(19) United States
(12) Patent Application Publication
(10) Pub. No.: US 2026/0054382 A1
(43) Pub. Date: Feb. 26, 2026

(54) AUTOMATIC CODE GENERATION FOR ROBOTIC MANIPULATION TASKS

(71) Applicant: Intrinsic Innovation LLC, Mountain View, CA (US)

(72) Inventors: Kaylee Carissa Burns, Stanford, CA (US); Stefan Schaal, Mountain View, CA (US)

(21) Appl. No.: 19/307,952

(22) Filed: Aug. 22, 2025

Related U.S. Application Data
(60) Provisional application No. 63/686,659, filed on Aug. 23, 2024.

(51) Int. Cl. B25J 9/16

(52) U.S. Cl. CPC B25J 9/1633

(57) ABSTRACT

Methods, systems, and apparatus, including computer programs encoded on computer storage media, for automatically generating code for contact-rich manipulation tasks by providing action space constraints to a large language model. One of the methods includes obtaining a library of available control methods for a robotic control system to cause a physical robot to move in an operating environment. The method further includes providing an input to an LLM that specifies a manipulation task to be performed using one or more of the available control methods and that specifies one or more action space constraints that constrain the physical movement of the robot in the operating environment according to forces sensed during performance of the manipulation task. Output code can be generated by the LLM, where the output code, when executed by the robotic control system, causes the physical robot to perform the manipulation task.

### CROSS-REFERENCE TO RELATED APPLICATIONS

This application claims priority to U.S. Provisional Application No. 63/686,659, filed on Aug. 23, 2024. The disclosure of the prior application is considered part of and is incorporated by reference in the disclosure of this application.

### BACKGROUND

This specification relates robotics, and more particularly to determining robotic policies for achieving a particular goal state.

Robotics control refers to controlling the physical movements of robots in order to perform tasks. For example, a robot can be programmed to pick up an object out of a bin and to place the object at a particular location in a work cell. Each of these actions can themselves include dozens or hundreds of individual movements by robot motors and actuators.

Robotics planning has traditionally required immense amounts of manual programming in order to meticulously dictate how the robotic components should move in order to accomplish a particular task. However, manual programming is error prone and does not generalize well to other environments.

Some research has been conducted toward using natural language inputs to specify goal states, including using language models to deduce the meaning of the natural language input. For example, a user can specify the natural language input, “place the hammer on the table,” and a system can try to understand this input and to generate a control policy that causes the robot to move to the goal state corresponding to the natural language input. However, these prior approaches are generally unsuitable for high-precision and contact-rich tasks.

An example high-precision task is peg insertion during which a robot is required to insert a peg into a hole, which is a common operation for tasks that involve furniture assembly. Being even 1 centimeter off can damage the parts, the robot, or both.

### SUMMARY

This specification describes how a system can automatically generate code for contact-rich manipulation tasks by providing action space constraints to a large language model. The action space constraints cause the large language model to generate code while reasoning about the interactions of the forces and robot parameters such as stiffness, for example.

Particular embodiments of the subject matter described in this specification can be implemented so as to realize one or more of the following advantages.

Large language models have been successful at generating output code, but the results have been limited to high-level tasks that do not require accurate movement. That is, while large language models have been able to demonstrate impressive generalization across different settings and target objects for manipulation tasks, such generalization is more difficult for contact-rich tasks where a higher level of precision is required. For example, for a peg-in-hole insertion task, surfaces with more friction or tight insertion tolerances may require multiple insertion attempts or contact force tuning to reach the insertion site.

However, the automatic code generation system described in this specification can generate output code, using a large language model with no specialized training, for contact-rich tasks by providing one or more action space constraints. That is, the techniques described in this specification enable a large language model to automatically generate output code for contact-rich manipulation tasks by specifying constraints on the stiffness, forces, and trajectories required to perform the manipulation task.

The techniques described in this specification provide a real-world technological advantage over prior robotic processes because a robotic control system can execute the automatically generated output code and outperform prior approaches when performing challenging contact rich manipulation tasks. The techniques also allow a robot to execute the automatically generated output code in order to perform notoriously difficult tasks including cable routing and unrouting.

The details of one or more embodiments of the subject matter will become apparent from the description, drawings, and the claims.

Other features, aspects, and advantages of the subject matter will become apparent from the description, drawings, and the claims.

### BRIEF DESCRIPTION OF THE DRAWINGS

FIG. 1 is an example automatic code generation system that generates output code for a robot using action space constraints.

FIG. 2A is an example peg-in-hole insertion task for a star peg.

FIG. 2B is an example peg-in-hole insertion task for a circular peg.

FIG. 2C is an example cable routing task.

FIG. 2D is an example cable unrouting task.

FIG. 3A is an example of failed execution of a high-precision peg-in-hole insertion task for a circular peg using a classic approach.

FIG. 3B is an example of failed execution of a high-precision peg-in-hole insertion task for a circular peg using an LLM without action space constraints.

FIG. 3C is an example of successful execution of a high-precision peg-in-hole insertion task for a circular peg using an LLM with action space constraints.

FIG. 4 is a flow diagram of an example code generation process using action space constraints.

Like reference numbers and designations in the various drawings indicate like elements.

### DETAILED DESCRIPTION

This specification generally describes an automatic code generation system that automatically generates code for high-precision, contact-rich manipulation tasks by specifying action space constraints to a large language model. More specifically, the automatic code generation system can specify constraints on the stiffness, forces, and trajectories required to perform contact-rich manipulation tasks to an LLM to enable the LLM to reason during code generation about motions of and forces acting on the object(s) handled during the manipulation task.

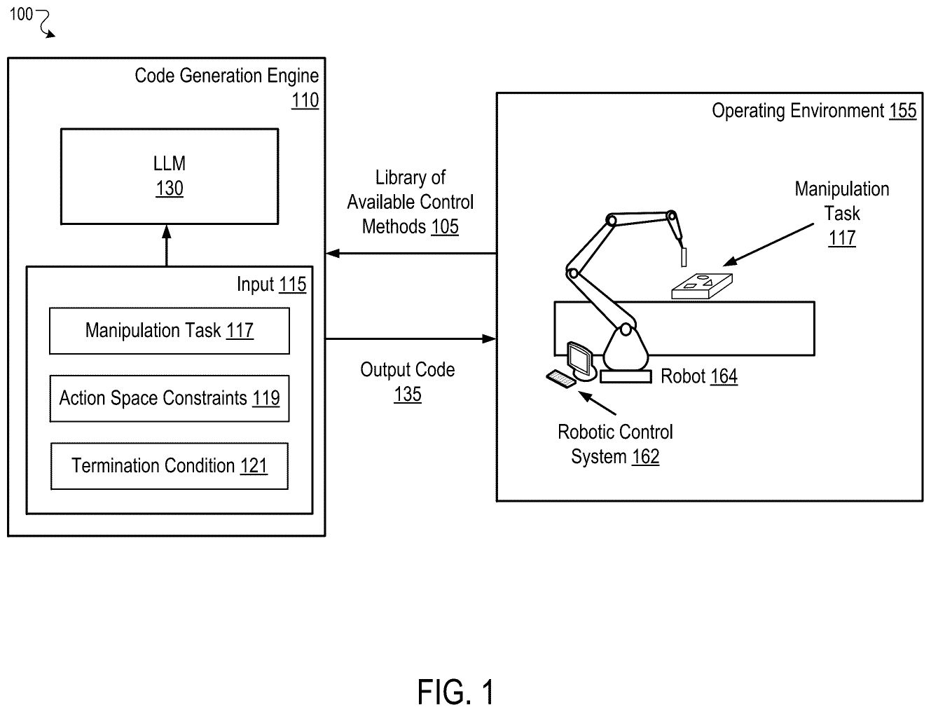

FIG. 1 is a diagram that illustrates an example system 100. The system 100 is an example of a system that can implement the techniques described in this specification. The example system 100 can be implemented as computer programs installed on one or more computers in one or more locations that are coupled to each other through any appropriate communications network, e.g., an intranet or the Internet, or combination of networks.

In particular, the automatic code generation system 100 is configured to generate output code 135 that when executed causes a robot 164 to move in an operating environment 155 to perform a manipulation task 117.

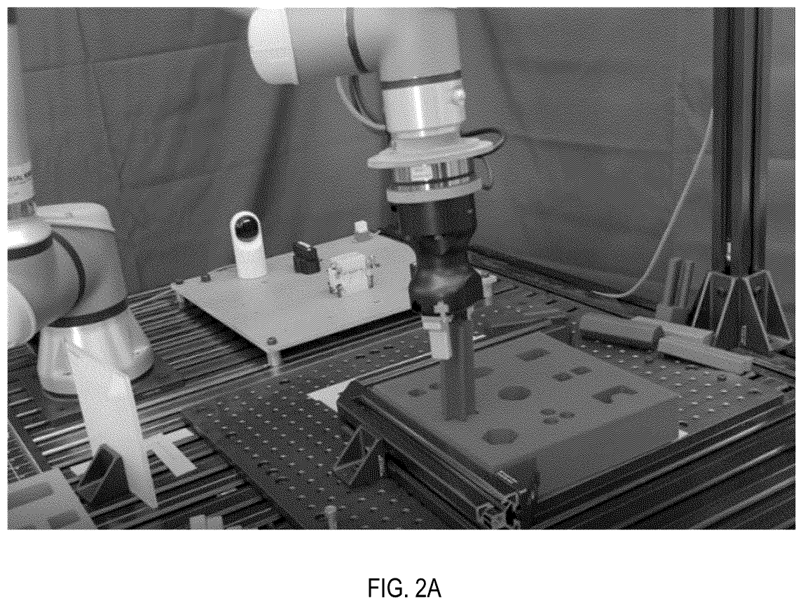

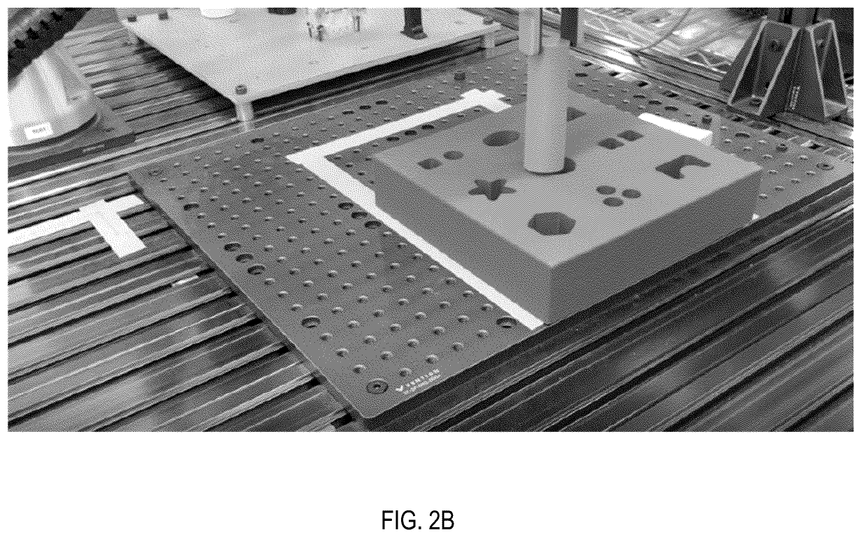

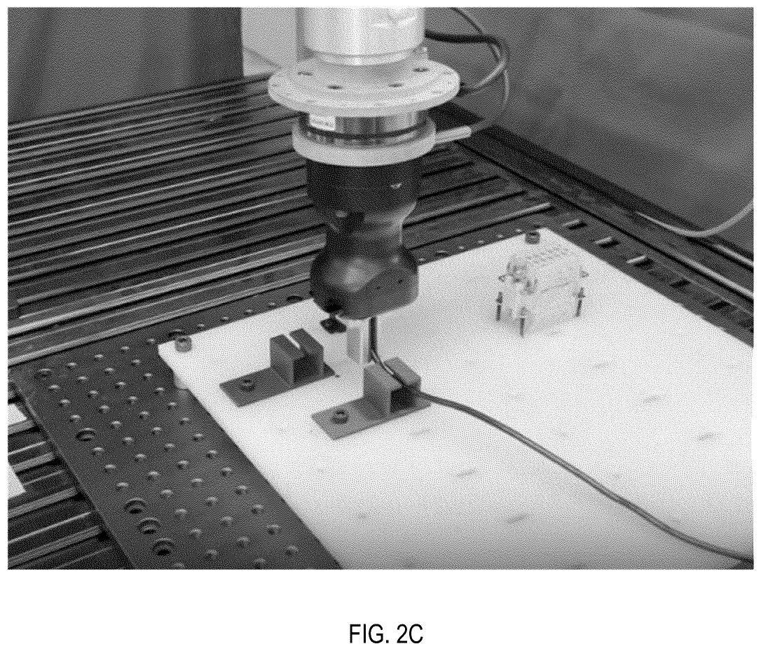

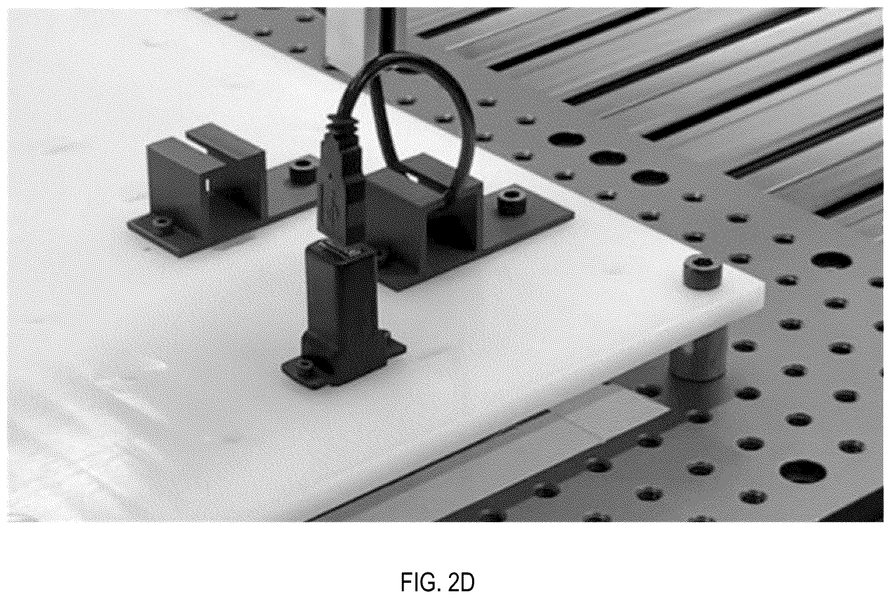

The automatic code generation system 100 can be utilized in any appropriate machine application to perform a manipulation task 117. For example, the automatic code generation system 100 can be utilized to perform high-precision contact-rich manipulation tasks, such as high-precision insertion, rigid body assembly, cable routing, and deformable object manipulation. As an example, as seen in FIG. 2A and FIG. 2B, the robot 164 can execute the output code 135 to perform high-precision peg-in-hole insertion tasks.

The automatic code generation system 100 can include a code generation engine 110 and an operating environment 155 in which to perform the manipulation task 117 using the generated output code 135.

The operating environment 155 can be, for example, a workcell and can include a robot 164 to execute the output code 135 to perform the manipulation task.

The operating environment 155 can further include one or more functional components to translate and execute the output code 135, such as a real-time robotic control system 162 that causes the (physical) robot 164 to move in the operating environment 155 to perform the manipulation task 117. The operating environment 155 can execute the output code 135 of the robotic control system 162 to cause the (physical) robot 164 to perform the manipulation task 117 including manipulating an object according to one or more action space constraints 119 as described in further detail below.

At a high level, a real-time robotic control system 162 of the operating environment 155 can receive the output code 135 and execute the robotic process outlined by the output code 135. Thus, when the real-time robotic control system 162 executes the output code 135, the real-time robotic control system 162 kicks off the appropriate action on the robot 164 in the operating environment 155.

To generate the output code 135, the code generation system 100 can utilize a code generation engine 110.

The code generation engine 110 can receive a library of available control methods 105 and using a large language model (LLM) 130, can generate output code 135 that when executed causes the robot 164 to perform a high-precision, contact-rich manipulation task.

More specifically, the automatic code generation system 100 can obtain a library of available control methods 105 for the robotic control system 162 of the operating environment 155 to cause the (physical) robot 164 to move in the operating environment 155. The library of available control methods 105 can represent, for example, one or more control methods available to the robot 164 to manage the robot's behavior and movement during performance of the manipulation task 117. The library of available control methods 105 can include any appropriate control method depending on the robot 164 and the operating environment 155.

In some implementations, the library of available control methods 105 for a robotic control system 162 can include a corresponding control method for all user requested commands. In some implementations, the library of available control methods 105 for a robotic control system 162 can include a corresponding control method for a subset of the user requested commands.

As a specific example, the available control methods 105 can include a point-to-point move, a compliant move, and a gripper move. In some implementations, the available control methods 105 can include one or more methods or variables specifying the positions of relevant objects in the operating environment 155.

A point-to-point move can refer to a control method that directly commands the robot 164 to move to a target pose in a Cartesian space. That is, the point-to-point move can command the robot 164 to move from a current pose (e.g., a first point) to a target pose (e.g., a second point) in the operating environment 155.

A compliant move can refer to, for example, a control method that allows the robot 164 to adapt its trajectory or force in response to environment interactions during a subtask of the manipulation task 117, such as, for example, contact with an object in the operating environment 155. In some implementations, the compliant move can be an impedance move.

An impedance move can refer to, for example, a control method that regulates the relationship between force and motion of a robot. More specifically, an impedance move can refer to a control method that allows the robot 164 to respond to external forces by adjusting its position, velocity, or acceleration.

In some implementations, the available control methods can be parameterized by one or more parameters, including one or more action space constraints 119. As a specific example, an impedance move can be parameterized by (i) a target pose in a Cartesian space, and (ii) a vector that specifies stiffness along each degree of freedom when the object the robot 164 is handling is in contact with the operating environment 155. That is, the impedance move can be parameterized by a target pose to which the robot 164 moves the object as well as an action space constraint, e.g., stiffness, that constrains or controls the contact of the object with the operating environment 155 during the manipulation task 117. The impedance move can allow the robot 164 to respond to contact with the operating environment 155, using the stiffness vector, to adjust the position and/or trajectory of the robot 164 during performance of the manipulation task 117.

As an example, the stiffness vector can specify the stiffness along each degree of the six degrees of freedom. The six degrees of freedom can refer to three translation degrees of freedom (DOFs) and three rotational DOFs. A translational DOF can represent a position along the x, y, or z orthogonal axis in a suitable coordinate system (e.g., Cartesian coordinate system). A rotational DOF can represent a rotation around the x, y, or z axis in a suitable coordinate system.

A gripper move can refer to a control method that specifies how to operate an effector of the robot 164, e.g., a gripper, so that the gripper can grasp, hold, and manipulate objects safely and effectively.

The code generation engine 110 can obtain the library of available control methods 105 and provide an input 115 to the LLM 130 to generate output code 135 for a manipulation task 117 using one or more of the available control methods 105 and that specifies one or more action space constraints 119. More specifically, the automatic code generation system 100 can provide an input 115 to the LLM 130 that specifies a manipulation task 117 to be performed using one or more of the available control methods and that specifies one or more action space constraints 119 that constrains the physical movement of the robot 164 in the operating environment according to forces sensed during performance of the manipulation task 117.

As described above, the code generation engine 110 can include an LLM 130. The LLM 130 can be any appropriate large language model that is configured to receive an input and to generate output code in response to the input. In this specification, a large language model (LLM) is a machine learning computing system that employs integrated self-attention computations on elements of an input sequence in order to autoregressively generate subsequent elements of an output sequence. Language models provide various computational advantages such as the ability to process large amounts of data in parallel, to process data from diverse sources, and an ability to generate semantic representations of words in context in a particular language. The techniques described in this specification can be implemented using language models that are encoder-decoder systems or decoder-only systems.

The automatic code generation system 100 can provide the input 115 in any appropriate manner. In some implementations, the automatic code generation system 100 can provide the input 115 as a prompt. The prompt can be any natural language prompt including one or more prompt elements. The one or more prompt elements can be any prompt elements, including (i) a manipulation task 117 description, (ii) one or more action space constraints 119, (iii) a description of the available control methods, (iv) a termination condition 121, (v) one or more hints, (vi) one or more spatial patterns, and (vii) one or more examples.

The manipulation task 117 description can refer to, for example, a high level description of the operating environment 155 and manipulation task goal written in natural language. The manipulation task 117 description can include important information about the manipulation task setup, e.g., peg shape in a peg-in-hole insertion task or the available objects for the manipulation task.

The one or more action space constraints 119 can refer to, for example, one or more constraints that constrain the physical movement of the robot 164 in the operating environment 155 according to forces sensed during performance of the manipulation task 117. The one or more action space constraints 119 can be any action space constraint, including a stiffness constraint and a force constraint that specifies a maximum force during performance of the manipulation task.

The description of available control methods can refer to, for example, formatted doc-strings that describe the code that can be used by the LLM 130, e.g., doc-strings describing the library of available control methods 105. For example, the description of available control methods can include lists of available variables as well as the expected range of values for floating point numbers. In some implementations, the description of the available control methods can further specify methods or variables that represent the position of an object in the environment.

In some implementations, the description of available control methods can include one or more corresponding parameters for one or more of the one or more action space constraints 119. For example, a compliant move control method can include a stiffness constraint. The stiffness constraint can constrain the interaction forces that the robot 164 will impart on the environment while performing a manipulation task. That is, the automatic code generation system 100 can set, by the robotic control system 162 of the operating environment 155, a stiffness parameter of the physical robot 164 according to the stiffness constraint. A low stiffness constraint can enable the robot 164 to maintain gentle contact with a surface that prevents the robot 164 from reaching a desired position, while a higher stiffness constraint can create higher contact forces, equivalent to a higher priority to reduce position error.

In some implementations, the description of available control methods can include descriptions for each control method in the library of available control methods 105. In some implementations, the description of available control methods can include descriptions for a subset of control methods in the library of available control methods 105.

The termination condition 121 can refer to, for example, a set of conditions under which to terminate a compliant move. More specifically, the termination condition 121 can represent a threshold on force or position in a specified coordinate direction that the robot 164 reaches during execution of the manipulation task 117. For example, when contacting a surface, a robot can move a peg downward with a termination constraint on upward force.

In implementations in which the input 115 includes a definition of a termination condition 121, the output code 135 can include one or more references to the termination condition 121. For example, the output code 135 can specify termination of the manipulation task 117 when sensed forces exceed a force constraint. As a specific example, for the above termination constraint on upward force, the output code 135 can specify termination of the manipulation task 117 when sensed upward forces exceed zero (e.g., the robot 164 contacts the surface).

The one or more hints can refer to rules, keywords, and requests that can help guide the model towards motion patterns that are relevant to contact-rich manipulation tasks.

The spatial patterns can refer to, for example, symbolic summaries of a given scene and act as a character-based representation of what is visible to the LLM agent.

The examples can refer to examples of the control methods being used for basic movements, such as contacting a surface.

The automatic code generation system 100 can provide an input 115 that includes any combination of prompt elements. For example, the automatic code generation system 100 can provide an input 115 to the LLM 130 that includes (i) the manipulation task 117 description, (ii) the one or more action space constraints 119, and (iii) the description of the available control methods. In some implementations, the input 115 to the LLM 130 can further include (iv) a termination condition 121.

The LLM 130 can utilize the input 115, including the manipulation task 117, the action space constraints 119 used to parameterize the available control methods 105 and one or more termination conditions 121, to generate output code 135 for the robot 164 to execute to perform the manipulation task 117.

That is, the automatic code generation system 100 can receive, as output of the LLM 130, output code 135 that when executed by the robotic control system 162 in the operating environment 155 causes the (physical) robot 164 to perform the manipulation task 117. To perform the manipulation task 117, the output code 135 can call the one or more of the available control methods 105 using the one or more action space constraints 119.

After receiving the output code 135 from the LLM 130, the operating environment 155 can execute the output code 135 of the robotic control system 162 to cause the (physical) robot 164 to perform the manipulation task 117 including manipulating an object according to one or more action space constraints 119.

Using the code generation system 100 to generate output code 135, the robot 164 can perform the manipulation task 117 with a higher success rate in completion than previously utilized techniques as depicted in Table 1:

TABLE 1
Success Rates of Example Manipulation Tasks

| | Circle | Star | Half-Pipe |
|---|---|---|---|
| Scripted | 100% | 10% | 0% |
| Point-to-Point (PtP) (Zero-Shot) | 70% | 0% | 0% |
| Fixed Compliance (Zero-Shot) | 100% | 70% | 30% |
| Ours (Zero-Shot) | 100% | 80% | 50% |

Each of the techniques in Table 1 is measured against the functional manipulation benchmark. The functional manipulation benchmark studies robotic manipulation, grasping, reorienting, and assembling of a set of dozens of 3D printed objects. For this specific example, the four techniques are evaluated on a set of peg-in-hole insertion tasks across three different object shapes: the circle, the star, and the half-pipe. For this evaluation, a script is first utilized to bring the pegs into a fixed position over the insertion points that includes a randomized rotation around the z axis.

The scripted technique is an approach that utilizes a scripted pattern search insertion move that is tuned by an expert on a single task setting. The scripted move implements fixed get-in contact, pattern search and insertion phases with durations, motion patterns, and force thresholds set by an expert. As seen above, the scripted technique works well when the specific orientation of the peg is not required as the scripted technique has a 100% success rate for a circle, but a 10% and a 0% success rate for a star and a half-pipe shaped peg.

The point-by-point technique is an approach in which a robot is directly commanded to move to Cartesian target poses. Similarly to the scripted technique, the point-to-point technique has more success with a peg that does not require a specific insertion orientation while the technique has a 0% success rate for the star and the half-pipe shaped peg.

The fixed compliance technique is an approach that utilizes an LLM to generate output code but does not include the stiffness and force constraints to the LLM as input and uses predefined parameters for compliant move control methods. That is, while the fixed compliance technique adds a compliant move that enables the robot to adapt to contact with surfaces of the operating environment when performing the manipulation task, the compliant move is not parameterized by one or more action space constraints, e.g., stiffness and force. As seen in Table 1, the fixed compliance technique is more successful for the star and half-pipe manipulation tasks with which the other previous techniques had trouble. However, as seen in Table 1, the addition of the action space constraints leads to higher success rates.

The final technique in Table 1 is the approach described in this specification in which the LLM receives the force and stiffness constraints as well as the termination conditions corresponding to those action space constraints as input. This specific example is a zero-shot technique in which the robot does not receive any example of code being used for the manipulation task, meaning that every command is an unseen command. As demonstrated in Table 1, the usage of the action space constraints, e.g., force and stiffness constraints, can lead to a success rate of 100% for circle peg insertion, 80% for star peg insertion and 50% for half-pipe insertion. The last approach has significantly higher success rates than the first two previously utilized methods for the star and half-pipe shaped pegs and has the highest success rate across any of the techniques.

FIGS. 2A, 2B, 2C, and 2D illustrate examples of high-precision, contact-rich manipulation tasks.

FIGS. 2A and 2B illustrate examples of high-precision, contact-rich peg-in-hole insertion tasks. As seen in FIG. 2A and FIG. 2B, the star-shaped peg must be inserted into the star-shaped hole and the circular peg must be inserted into the circular hole.

For peg-in-hole insertion tasks, surfaces with more friction or tight insertion tolerances can require multiple insertion attempts or contact force tuning to reach the insertion site. For example, the star-shaped peg must be inserted into the hole in a specific orientation to align the points of the star with the star-shaped hole. That is, pegs with different geometries need different approach trajectories to achieve proper alignment: a star-shaped peg may require an initial rotation for insertion where a circular peg requires no rotation. This can make it difficult for the robot to generalize across peg-in-hole insertion tasks for different shaped pegs. Traditionally, the parameters of contact-rich insertion skills are mostly tuned by experts to handle the differences in the trajectories for different shaped pegs. However, the automatic code generation system, e.g., the automatic code generation system 100 described in FIG. 1, can automatically generate code that allows the robot to generalize across different shaped pegs.

FIGS. 2C and 2D illustrate examples of high-precision, contact-rich cable routing and unrouting tasks. As seen in FIGS. 2C and 2D, cable routing and unrouting requires high-precision to route or unroute the cable through small objects, e.g., a tunnel with an opening. Cable routing and unrouting is difficult because it requires the robot to navigate small openings and contact with one or more surfaces of an operating environment. For example, in the cable unrouting task, the cable is inserted into a tunnel with an opening on the top and the robot has to find the opening of the tunnel and move the cable so that it goes through the opening and does not snag on any portion of the tunnel. Additionally, cables are flexible and deformable, which can make routing and unrouting a bit more difficult as the behavior of the cables after contact with a surface of the operating environment can be difficult to predict or control. However, the automatic code generation system, e.g., the automatic code generation system 100 described in FIG. 1, can automatically generate code that allows the robot to adapt to surface contact and successfully perform cable routing and unrouting tasks.

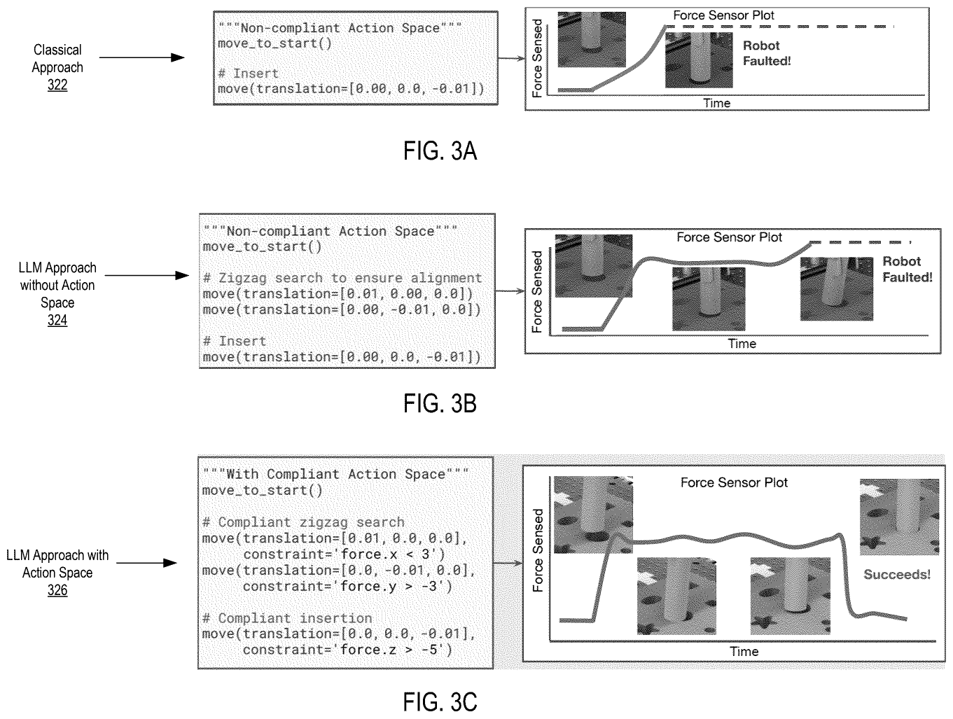

FIGS. 3A, 3B, and 3C are examples of execution of a high-precision peg-in-hole insertion task using different approaches to generate output code for a robot to execute to perform the task. Each of the example approaches includes output code, and a force sensor plot that is used to demonstrate the result of the execution of the output code.

FIG. 3A is an example of failed execution of a high-precision peg-in-hole insertion task using a classical approach, or in other terms, a naïve approach.

As depicted in FIG. 3A, the output code generated using the classical approach 322 is a single line of code that does not consider forces or any uncertainty or errors in the pose estimation of the peg and the hole, leading to failed execution of the manipulation task. Furthermore, by not considering contact forces between the peg and the hole and not terminating the task when contact is made between the peg and the surface surrounding the hole, the output code generated by the classical approach 322 will probably result in something getting broken or ruined in the operating environment.

FIG. 3B is an example of failed execution of a high-precision peg-in-hole insertion task using an LLM without action space constraints 324.

To generate the output code, the code generation system, e.g. the code generation system 100 of FIG. 1, can input a prompt to an LLM to generate code for a high-precision peg-in-hole insertion task. As demonstrated in FIG. 3B, as opposed to the classic approach 322, the LLM is able to identify the need for a zigzag search to ensure alignment of the peg in the hole and includes the zigzag search in the output code.

However, the LLM does not include a compliant action space that includes force constraints that allows the robot to adapt to contact with a surface. As demonstrated in the force sensor plot, the robot reaches a force threshold in which the robot faults and the manipulation task cannot be completed.

FIG. 3C is an example of successful execution of a high-precision peg-in-hole insertion task using an LLM with action space constraints.

The LLM of FIG. 3C has all of the positives of FIG. 3B, e.g., the LLM is able to identify the need for a zigzag search to ensure alignment of the peg in the hole and includes the zigzag search in the output code. However, to generate the output code, the code generation system, e.g. the code generation system 100 of FIG. 1, can input a prompt to an LLM to generate code for a high-precision peg-in-hole insertion task and can include force constraints in the compliant move control methods of the robot.

As demonstrated in FIG. 3C and particularly in the force sensor plot of FIG. 3C, the robot is able to successfully complete the peg-in-hole insertion task by managing the force of the robot. As seen in the output code, the introduction of force constraints enables the robot to complete the task.

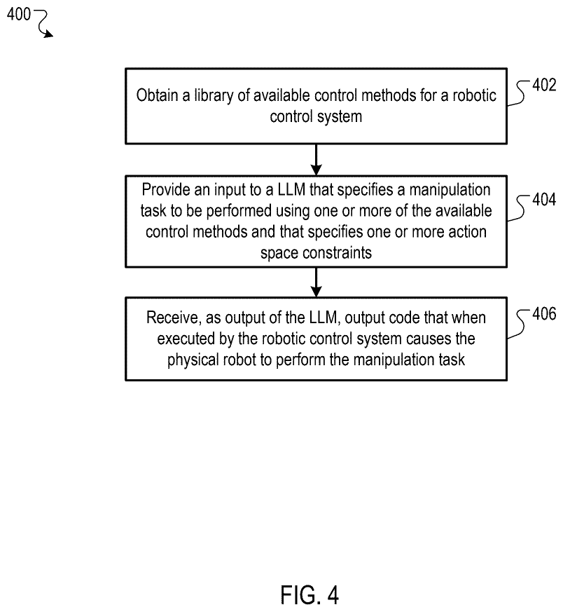

FIG. 4 is a flow diagram of an example code generation process using action space constraints.

For convenience, the process 400 will be described as being performed by a system of one or more computers located in one or more locations. For example, a system, e.g., the system 100 depicted in FIG. 1, appropriately programmed in accordance with this specification, can perform the process 400.

The system can obtain a library of available control methods for a robotic control system (step 402). As described with reference to FIG. 1, the library of available control methods can include any appropriate control method given the robot and the operating environment. For example, the available control methods can include a point-to-point move, a compliant move, and a gripper move.

The system can provide an input to a large language model that specifies a manipulation task to be performed using one or more of the available control methods and that specifies one or more action space constraints that constrain the physical movement of the robot in the operating environment according to forces sensed during the performance of the manipulation task (step 404). As described in FIG. 1, in some implementations, the system can provide an input to the LLM that can include a combination of one or more of (i) a manipulation task description, (ii) a description of the available control methods, (iii) one or more action space constraints and (iv) one or more termination conditions. In some implementations, the input can include the one or more available control methods parameterized by one or more of the one or more action space constraints. In some implementations, the input can specify a method or variable that represent the position of an object in the environment. In implementations in which the input can specify a definition of a termination condition, the subsequent generated output code can include one or more references to the termination condition. The one or more action space constraints can be any appropriate action space constraint, including, but not limited to, a stiffness constraint and/or a force constraint that specifies a maximum force during performance of the manipulation task. In an implementation in which one of the one or more action space constraints is a stiffness constraint, the system can set, by the robotic control system, a stiffness parameter of the physical robot according to the stiffness constraint.

The system can receive, as output of the large language model, output code that when executed by the robotic control system causes the physical robot to perform the manipulation task (step 406). As described in FIG. 1, the output code can be executed by the robot in the operating environment to perform the manipulation task. More specifically, the output code can be executed on the robotic control system to cause the physical robot to perform the manipulation task including manipulating an object according to the one or more action space constraints. In particular, the output code can call one or more available control methods using the one or more action space constraints. As described above, in an implementation in which one of the one or more action space constraints is a force constraint, the output code can specify termination of the manipulation task when sensed forces exceed the force constraint.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A computer-implemented method comprising:
obtaining a library of available control methods for a robotic control system to cause a physical robot to move in an operating environment;
providing an input to a large language model (LLM) that specifies a manipulation task to be performed using one or more of the available control methods and that specifies one or more action space constraints that constrain the physical movement of the robot in the operating environment according to forces sensed during performance of the manipulation task;
receiving, as output of the LLM, output code that when executed by the robotic control system causes the physical robot to perform the manipulation task, wherein the output code calls one or more of the available control methods using the one or more action space constraints.

2. The method of claim 1, further comprising executing the output code on the robotic control system to cause the physical robot to perform the manipulation task including manipulating an object according to the one or more action space constraints.

3. The method of claim 1, wherein the input further specifies a definition of a termination condition, and wherein the output code includes one or more references to the termination condition.

4. The method of claim 1, wherein the one or more action space constraints include a stiffness constraint.

5. The method of claim 4, further comprising setting, by the robotic control system a stiffness parameter of the physical robot according to the stiffness constraint.

6. The method of claim 1, wherein the one or more action space constraints include a force constraint that specifies a maximum force during performance of the manipulation task.

7. The method of claim 6, wherein the output code specifies termination of the manipulation task when sensed forces exceed the force constraint.

8. The method of claim 1, wherein the available control methods comprise a point-to-point move, a compliant move, and a gripper move.

9. The method of claim 1, wherein the input specifies methods or variables that represent the position of an object in the environment.

10. A system comprising: one or more computers and one or more storage devices storing instructions that are operable, when executed by the one or more computers, to cause the one or more computers to perform operations comprising:
obtaining a library of available control methods for a robotic control system to cause a physical robot to move in an operating environment;
providing an input to a large language model (LLM) that specifies a manipulation task to be performed using one or more of the available control methods and that specifies one or more action space constraints that constrain the physical movement of the robot in the operating environment according to forces sensed during performance of the manipulation task;
receiving, as output of the LLM, output code that when executed by the robotic control system causes the physical robot to perform the manipulation task, wherein the output code calls one or more of the available control methods using the one or more action space constraints.

11. The system of claim 10, further comprising executing the output code on the robotic control system to cause the physical robot to perform the manipulation task including manipulating an object according to the one or more action space constraints.

12. The system of claim 10, wherein the input further specifies a definition of a termination condition, and wherein the output code includes one or more references to the termination condition.

13. The system of claim 10, wherein the one or more action space constraints include a stiffness constraint.

14. The system of claim 13, further comprising setting, by the robotic control system a stiffness parameter of the physical robot according to the stiffness constraint.

15. The system of claim 10, wherein the one or more action space constraints include a force constraint that specifies a maximum force during performance of the manipulation task.

16. A computer storage medium encoded with a computer program, the program comprising instructions that are operable, when executed by data processing apparatus, to cause the data processing apparatus to perform operations comprising:
obtaining a library of available control methods for a robotic control system to cause a physical robot to move in an operating environment;
providing an input to a large language model (LLM) that specifies a manipulation task to be performed using one or more of the available control methods and that specifies one or more action space constraints that constrain the physical movement of the robot in the operating environment according to forces sensed during performance of the manipulation task;
receiving, as output of the LLM, output code that when executed by the robotic control system causes the physical robot to perform the manipulation task, wherein the output code calls one or more of the available control methods using the one or more action space constraints.

17. The computer storage medium of claim 16, further comprising executing the output code on the robotic control system to cause the physical robot to perform the manipulation task including manipulating an object according to the one or more action space constraints.

18. The computer storage medium of claim 16, wherein the input further specifies a definition of a termination condition, and wherein the output code includes one or more references to the termination condition.

19. The computer storage medium of claim 16, wherein the one or more action space constraints include a stiffness constraint.

20. The computer storage medium of claim 19, further comprising setting, by the robotic control system a stiffness parameter of the physical robot according to the stiffness constraint.
